(19) United States
(12) Patent Application Publication
(10) Pub. No.: US 2007/0187629 A1
(43) Pub. Date: Aug. 16, 2007

(54) OPTICAL COUPLING DEVICE

(75) Inventor: Hiroshi MATSUYAMA, Minato-ku, Tokyo (JP)

Correspondence Address: BANNER & WITCOFF, LTD.;ATTORNEYS FOR CLIENT NO. 000449, 001701, 1100 13th STREET, N.W., SUITE 1200, WASHINGTON, DC, 20005-4051, US

(73) Assignee: KABUSHIKI KAISHA TOSHIBA, Tokyo (JP)

(21) Appl. No.: 11/610,706

(22) Filed: Dec. 14, 2006

(30) Foreign Application Priority Data
Dec. 14, 2005 (JP) 2005-360422

(51) Int. Cl. G02B 27/00

(52) U.S. Cl. 250/551

(57) ABSTRACT

An aspect of the present invention provides an optical coupling device which includes a light emitting element, a photodetector element, and a switching circuit having first and second semiconductor elements and electrodes. The photodetector element receives light from the light emitting element. In the switching circuit, the first and second semiconductor elements are disposed so as to face each other, and are turned on and off as being controlled by a signal from the photodetector element. The electrodes are respectively formed on surfaces, facing each other, of the first and second semiconductor elements, and are connected to each other.

### CROSS REFERENCE TO RELATED APPLICATION

This application is based upon and claims the benefit of priority from Japanese Patent Application No. P2005-360422, filed on Dec. 14, 2005, the entire contents of which are incorporated herein by reference.

### BACKGROUND OF THE INVENTION

An optical coupling device, which is also called a semiconductor relay device, is used in various apparatuses. Above all, the use of the optical icoupling device as a replacement for a mechanical relay of an IC (integrated circuit) tester has recently increased. The main reasons for using the optical coupling device are that the device can provide electrical isolation between an IC to be measured and a system of measurement, and that the device has a long life due to having no contact points. As for another requirement specification, it is desired to achieve an improvement in high-frequency characteristics of the device.

As the operating speed of the IC increases, the operating speed of a signal to be used in the IC tester requires frequencies of the order of several hundreds of megahertz (MHz) or a gigahertz (GHz). Correspondingly, the optical coupling device also needs to operate at higher frequencies.

The optical coupling device includes a light emitting element, a photodetector element and a switching circuit. Two vertical power MOS transistors (or MOS elements) of the switching circuit are connected to each other by a bonding wire providing a connection between the respective sources of the two MOS transistors. Even when the device is adapted to achieve higher speed, the bonding wire is still used for the connection between the sources of the two vertical MOS elements.

However, the bonding wire that provides the connection between the two MOS elements of the switching circuit of a conventional optical coupling device has an inductance which depends on the diameter and the length of the bonding wire. When an attempt is made to pass a high-speed signal through a signal transmission path having the switching circuit, the bonding wire has noticeable inductance components, which cause the problem of degrading the quality of a waveform as the high-frequency characteristics, that is, the problem of rendering it difficult to transmit the high-speed signal.

### SUMMARY OF THE INVENTION

Aspects of the invention relate to an improved optical coupling device.

### BRIEF DESCRIPTION OF THE DRAWINGS

FIG. 1A is a perspective view of an optical coupling device in accordance with a first embodiment. FIG. 1B is a cross sectional view of the optical coupling device taken along A-A line in FIG. 1A.

FIG. 2 is an equivalent circuit diagram of the optical coupling device in accordance with the first embodiment.

FIG. 3 is a cross sectional view of the optical coupling device taken along A-A line in FIG. 1A.

FIG. 4 is a perspective view of an optical coupling device in accordance with a second embodiment.

FIGS. 5A and 5B are bottom views of the optical coupling device in accordance with the second embodiment.

FIG. 6A is a perspective view of an optical coupling device in accordance with a third embodiment. FIG. 6B is a cross sectional view of the optical coupling device taken along B-B line in FIG. 6A.

FIG. 7 is an equivalent circuit diagram of the optical coupling device in accordance with the third embodiment.

FIG. 8A is a sectional view of the optical coupling device in accordance with the third embodiment. FIG. 8B is a diagram showing a characteristic impedance of a signal wire in the optical coupling device in accordance with the third embodiment.

FIG. 9 is a voltage wavelength of the optical coupling device with a base board and without the base board.

FIG. 10 is a perspective view of an optical coupling device in accordance with a fourth embodiment.

FIG. 11 is a perspective view of an optical coupling device in accordance with a fifth embodiment.

FIG. 12 is a perspective view of an optical coupling device in accordance with a sixth embodiment.

FIG. 13 is a cross sectional view of the optical coupling device taken along C-C line in FIG. 12.

FIG. 14 is an equivalent circuit diagram of the optical coupling device in accordance with the sixth embodiment.

FIG. 15 is a cross sectional view of an optical coupling device in accordance with a seventh embodiment, showing a cross section of MOS element and therearound.

### GENERAL OVERVIER

An aspect of the present invention provides an optical coupling device which includes a light emitting element, a photodetector element and a switching circuit having first and second semiconductor elements and electrodes. The photodetector element receives light from the light emitting element. In the switching circuit, the first and second semiconductor elements are disposed so as to face each other, and are turned on and off under control based on a signal from the photodetector element. The electrodes are respectively formed on surfaces, facing each other, of the first and second semiconductor elements, and are connected to each other,.

Another aspect of the present invention provides an optical coupling device which includes a light emitting element, a photodetector element and a switching circuit. The photodetector element receives light from the light emitting element. The switching circuit includes a first and second MOS elements. The first MOS element is turned on and off under control based on a signal from the photodetector element. The second MOS element is disposed so as to overlap the first MOS element. A gate of the first MOS element is connected to a gate of the second MOS element with a bonding material, and a source of the first MOS element is connected to a source of the second MOS element with a bonding material.

### DESCRIPTION OF THE PREFERRED EMBODIMENTS

Various connections between elements are hereinafter described. It is noted that these connections are illustrated in general and, unless specified otherwise, may be direct or indirect and that this specification is not intended to be limiting in this respect.

Embodiments of the present invention will be explained with reference to the drawings as next described, wherein like reference numerals designate identical or corresponding parts throughout the several views.

Embodiments of the present invention will be explained with reference to the drawings as follows.

### First Embodiment

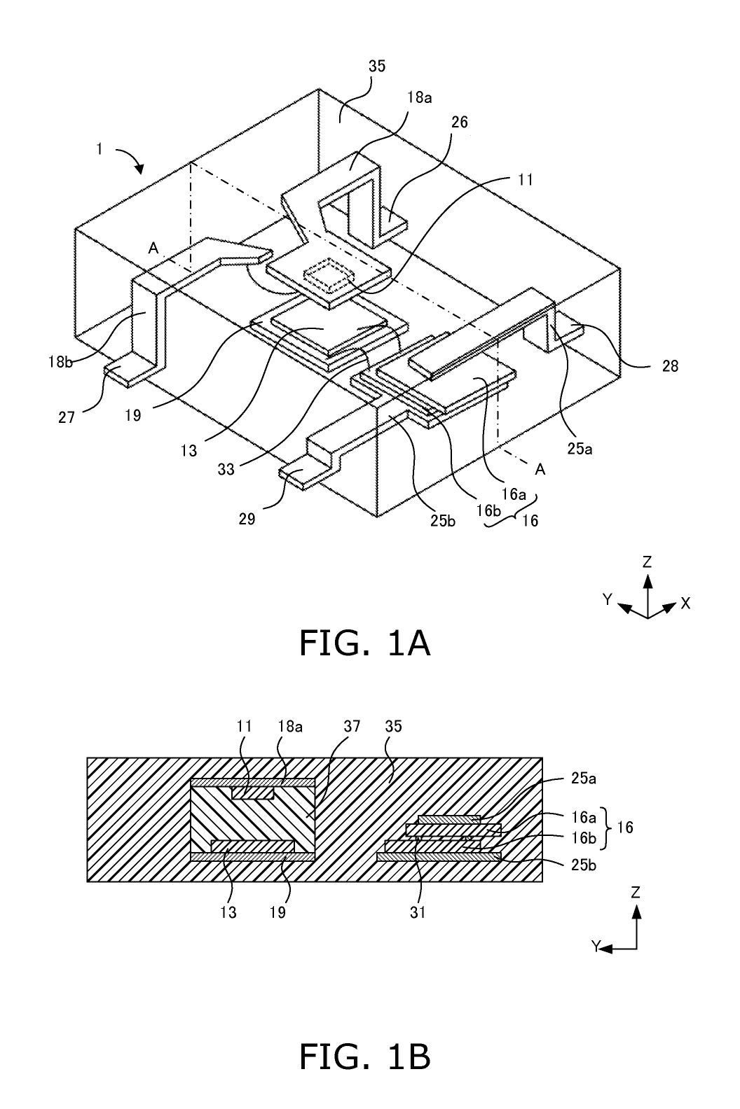

With reference to FIGS. 1A to 3, the descriptions will be given of an optical coupling device in accordance with a first embodiment of the present invention.

As shown in FIGS. 1A and 1B, an optical coupling device 1 includes a light emitting element 11, a photodetector element array 13 which is a photodetector element for receiving light from the light emitting element 11, a switching circuit 16 which causes an external circuit (not shown) to operate upon receipt of a signal originating from the received light, and signal wires 25a and 25b each of which connects the switching circuit 16 to the external circuit. The switching circuit 16 is configured of MOS elements 16a and 16b which are first and second semiconductor elements, respectively, and the MOS elements 16a and 16b face each other, and are connected to each other.

These structural components, except for terminals 26 and 27 for a light emitting element and signal terminals 28 and 29 which are exposed, are encapsulated and fixed in a mold resin 35. The end respectively of the terminals 26 and 27 for a light emitting element and the signal terminals 28 and 29 protrude through the side surfaces of the mold resin 35. The bottom surfaces, as well as the portions which are not protruded, of and the terminals 26 to 29 are exposed from the mold resin 35. The exposed portions form a mounting surface.

The light emitting element 11 is, for example, an LED (light emitting diode) which emits an infrared beam of light. A luminescence surface of the light emitting element 11 faces toward the bottom surface of the optical coupling device 1. The rear surface (i.e., an anode) of the light emitting element 11 is fixedly and electrically connected to a wiring 18 made of a lead frame, the rear surface of the light emitting element 11 being opposite the luminescence surface. One end of the wiring 18 has the terminal 26 for a light emitting element, and the other end of the wiring 18 is connected to the rear surface of the light emitting element 11. The luminescence surface (i.e., a cathode) of the light emitting element 11 is electrically connected, by a bonding wire 33, to another wiring 18 made of a lead frame. One end of this wiring 18 has the terminal 27 for a light emitting element, and the other end of the wiring 18 is connected to the luminescence surface of the light emitting element 11.

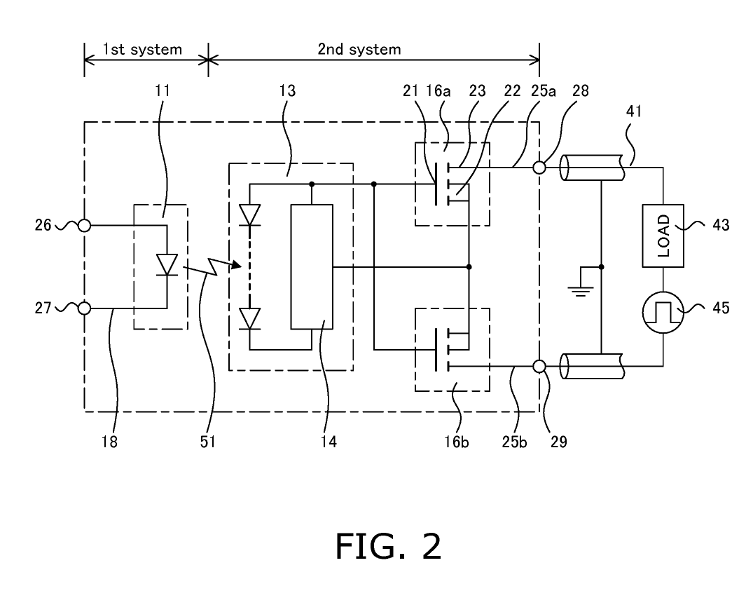

As shown in FIG. 2, the photodetector element array 13 has a circuit configuration of cascade connection in which the plurality of photodetector elements that are photovoltaic elements are connected to each other in series. A MOS gate discharging circuit 14 is formed in the photodetector element array 13. The MOS gate discharging circuit 14 serves to turn on or off a current at high speed by discharging residual charge in the gates of the MOS elements 16a and 16b. The MOS gate discharging circuit 14 is connected to each of the anode and cathode of the photodetector element array 13. A photodetection surface of the photodetector element array 13 faces the luminescence surface of the light emitting element, with a gap interposed in between. A rear surface of the photodetector element array 13 is electrically connected and fixed to a wiring 19 made of a lead frame, the rear surface being opposite the photodetection surface.

An interstice between the light emitting element 11 and the photodetector element array 13, which are disposed so as to face each other, is filled with a transparent resin 37, such as a silicon-base resin or an epoxy-base resin. The transparent resin permeates the wavelength of light emitted from the light emitting element 11, and has high electrical insulation properties. Thereby, optical coupling and electrical insulation are assured. The transparent resin 37 is coated with the mold resin 35, and is thus shielded from light. An example of the mold resin 35 is an epoxy-base resin which is opaque and high in electrical insulation properties.

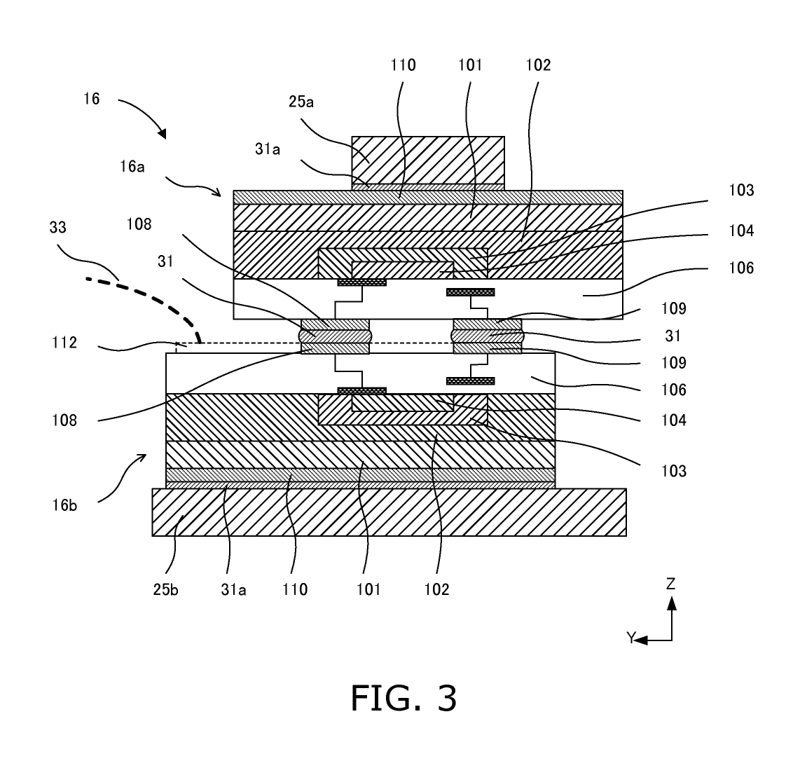

As shown in FIG. 3, each of the MOS elements 16a and 16b of the switching circuit 16 is a vertical MOSFET (Metal Oxide Semiconductor Field Effect Transistor), which includes a semiconductor substrate 101; a gate 21 (or a gate electrode 109) and a source 22 (or a source electrode 108) which are formed on a principal surface of the semiconductor substrate 101; and a drain 23 (or a drain electrode 110) formed on a rear surface (and the substrate) opposite the principal surface. The MOS elements 16a and 16b have substantially the same characteristics.

For example, the MOS element 16b includes the n type semiconductor substrate 101 toward the bottom surface of the structure; an n type layer 102 formed on the n type semiconductor substrate 101; a p type region 103 formed in the n type layer 102; an n type region 104 which is formed in the p type region 103, and which is connected to the source electrode 108; and an insulating film 106 formed in contact with the top surfaces respectively of the n type layer 102, the p type region 103, the n type region 104 and the like. The gate electrode 109 is disposed above the top surface of the p type region 103 with the insulating film 106 interposed in between. The drain electrode 110 is disposed on the bottom surface of the n type semiconductor substrate 101. A chip wiring 112 (shown by the dashed lines in FIG. 3) connected to the source electrode 108 and to the gate electrode 109, lies on the insulating film 106, and extends out to the periphery of the MOS element 16b. Incidentally, there is a great difference in scale between the inside of the semiconductor on the part of the semiconductor substrate 101 and the part having the chip wiring 112 opposite to the semiconductor substrate 101 which are located with the insulating film 106 interposed in between. The part having the insulating film 106, as a scale adjusting region, forms connections in the structure.

The MOS element 16b is located toward the bottom surface of the structure with respect to the MOS element 16a. The MOS element 16b is disposed so as to be displaced in a horizontal direction from the MOS element 16a in a way that the MOS element 16b can be connected, with the bonding wire 33, to the chip wiring 112 for connecting the gate electrode 109 to the photodetector element array 13. The principal surface of the MOS element 16a is faced with that of the MOS element 16b. The gate electrodes 109 of the MOS elements 16a and 16b are electrically and mechanically connected to each other with a bonding material 31, and the source electrodes 108 thereof are connected to each other in the same manner.

The bonding material 31 is, for example, solder in a bump form, but may be in the form of a thin sheet after connecting the MOS elements to each other. Incidentally, in order to ensure the mechanical strength of the switching circuit 16, the MOS elements 16a and 16b facing each other may be connected to each other with two or more solder bumps, and/or a resin-base filler may fill an interstice between the MOS elements 16a and 16b.

The top side (or the side opposite the bottom surface) of the rear surface (at the upper part of FIG. 3) of the MOS element 16a is connected, with a bonding material 31a such as solder, to the signal wire 25a made of a lead frame. One end of the signal wire 25a has the signal terminal 28. The other end of the signal wire 25a is connected to the MOS element 16a. The bottom surface of the rear surface of the MOS element 16b is connected, with the bonding material 31a, to the signal wire 25b made of a lead frame. One end of the signal wire 25b has the signal terminal 29. The other end of the signal wire 25b is connected to the MOS element 16b. Thereby, continuity is achieved between the sources 22 and the drains 23 of the MOS elements 16a and 16b. Thus, a transmission path for signals, such as a high-frequency signal, is ensured to run in the order of the signal terminal 28, the signal wire 25a, the MOS element 16a, the joining material 31, the iMOS element 16b, the signal wire 25b, and the signal terminal 29, as well as in the direction opposite the above order. This enables bidirectional transmission.

As shown in FIGS. 1A and 1B, the signal wire 25b mounting the switching circuit 16 and the wiring 19 mounting the photodetector element array 13 disposed side by side with space interposed in between. The signal wire 25b and the wiring 19 are disposed at about the same height above the bottom surface of the mold resin 35. As shown in FIGS. 1A and 1B and FIG. 3, the gate 21 (or the gate electrode 109) and the source 22 (or the source electrode 108) of the MOS element 16b are connected to the photodetector element array 13 with the bonding wire 33. The distance (or the difference in height) between the wiring 18 mounting the light emitting element 11 and the wiring 19 mounting the photodetector element array 13 is greater than that between the signal wires 25a and 25b on which the parts of the switching circuit 16 are respectively mounted.

As shown in FIG. 2, in the optical coupling device 1, the light emitting element 11 and the terminals 26 and 27 for light emitting element which form the primary side, are electrically insulated, with the mold resin 35 and the transparent resin 37, from the photodetector element array 13, the switching circuit 16, the signal terminals 28 and 29, and the like, which form the secondary side. In other words, this configuration suppresses the electrical effect of the primary side upon the signal transmission path of the optical coupling device 1 connected to external circuits, such as a load 43 and a signal generator 45, with an external signal wire 41.

An equivalent circuit of FIG. 2 merely illustrates the connection between the sources 22 of the MOS elements 16a and 16b. Meanwhile, this connection is made with the solder bumps as mentioned above. The height of the connected bumps is of the order of ten to several tens of micrometers (μm). Thereby, the height is reduced by the order of one to two digits as compared to the length of a conventional bonding wire, e.g., about 1 mm. For this reason, inductance components is reduced. i

The descriptions will now be given of an operation of the optical coupling device 1. As shown in FIG. 2, firstly, in a case where a current is not fed across the terminals 26 and 27 for a light emitting element, the light emitting element 11 does not emit light. Hence, the photodetector element array 13 does not generate a voltage. As a result, the gates 21 of the MOS elements 16a and 16b are not biased, and thus there is no continuity between the sources 22 and the drains 23 of the MOS elements 16a and 16b (that is, the circuit is open). In other words, input of a voltage signal to the signal terminal 28 does not lead to output of the voltage signal from the signal terminal 29.

In contrast, in a case where a current is fed through the anode (not ishown) of the light emitting element 11 via the terminal 26 for a light emitting element, the light emitting element 11 emits light to the photodetector element array 13. Upon receipt of the light, the photodetector element array 13 generates a voltage. The voltage is applied to the gates 21 of the MOS elements 16a and 16b to bias the gates 21, and thus there is continuity between the sources 22 and the drains 23 of the MOS elements 16a and 16b (that is, the circuit is closed). Thus, a voltage signal input into the signal terminal 28, e.g., a high-frequency signal, is output from the signal terminal 29 via the MOS elements 16a and 16b. Incidentally, the bias voltage applied to the gates 21 of the MOS elements 16a and 16b is raised to four or more volts, or to ten or more volts as needed, by cascade connection of low voltages generated by the individual photodetector elements. In a case where the current across the terminals 26 and 27 for a light emitting element is then turned off, the MOS gate discharging circuit 14 quickly discharges residual charge in the gates 21 of the MOS elements 16a and 16b. Thereby, there is no continuity between the MOS elements 16a and 16b.

As mentioned above, in the optical coupling device 1, the primary side which is configured of the light emitting element 11 and the terminals 26 and 27 for a light emitting element, is electrically insulated from the secondary side which is configured of the photodetector element array 13, the switching circuit 16, the signal terminals 28 and 29, and the like. In the switching circuit 16, the sources 22 of the MOS elements 16a and 16b, which face each other, are connected to each other with the bonding material 31 made of the solder bump. High-frequency signal or other signal transmission on the secondary side is controlled in accordance with whether or not there is continuity through the switching circuit 16 in response to whether or not the light emitting element 11 emits light.

The optical coupling device 1 in accordance with the first embodiment uses the bonding material 31 made of the solder bump in place of the conventional bonding wire. Thereby, the optical coupling device 1 suppresses a characteristic impedance mismatch of the bonding material 31 connecting the MOS elements 16a and 16b to each other. Thus, the reflection of a high-frequency input signal is reduced. Moreover, the bonding material 31 made of the solder bump is capable of reducing the inductance components to such a level that the inductance components are almost negligible. Thus, the optical coupling device 1 may suppress the insertion loss of the high-frequency signal. Consequently, the optical coupling device 1 suppresses degradation in the quality of the waveform of the high-frequency input signal, thus making it possible to increase the range of operating frequencies of a transmitted signal to the range of frequencies exceeding the order of a gigahertz, the frequency range having heretofore been limited to up to the order of several hundreds of megahertz.

Moreover, the switching circuit 16 is of the following size two-dimensionally. Specifically, the size is equal to the sum of an area of the MOS elements 16a and 16b and the area formed by displacing the MOS element 16b from the MOS element 16a in order for the bonding to be possible. Thus, the two-dimensional size of the switching circuit 16 is smaller than that of a conventional switching circuit in which the MOS elements 16a and 16b are arranged in parallel in the same plane. As for a dimension along the height, the switching circuit 16 has the height which is equal to the sum of the thickness of the two MOS elements 16a and 16b and the height of the solder bumps. This height of the switching circuit 16 is less than that of an optical coupling section formed of the light emitting element 11 and the photodetector element array 13. Thus, the optical coupling device 1 is not greater in height than a conventional optical coupling device. Accordingly, a mounting area of the optical coupling device 1 can be made smaller than that of the conventional optical coupling device.

### Second Embodiment

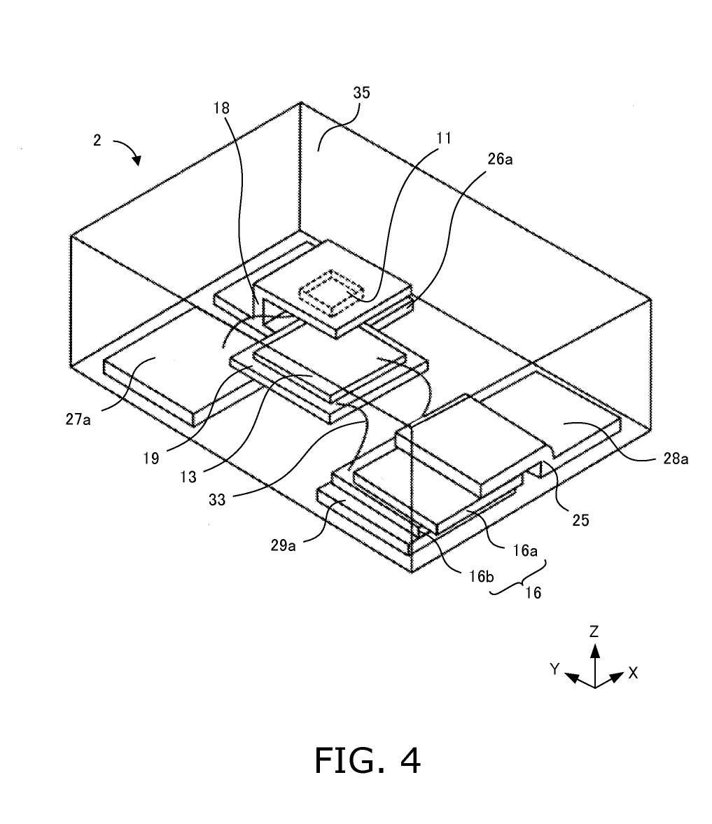

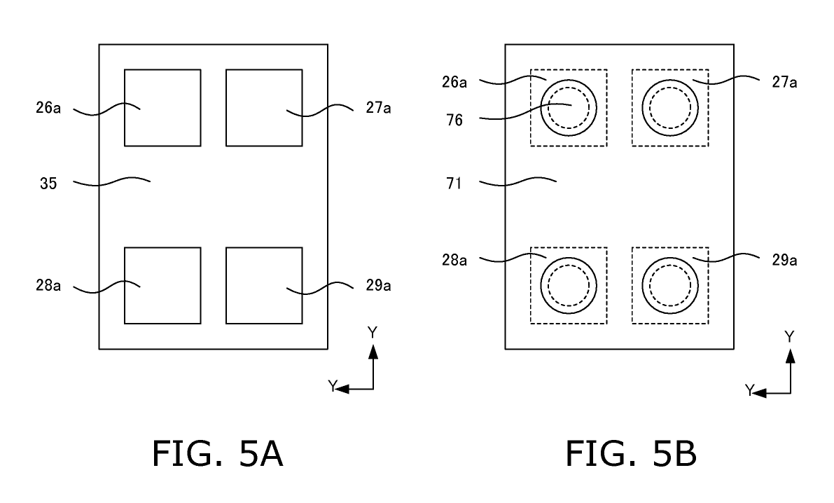

With reference to FIG. 4 and FIGS. 5A and 5B, the descriptions will be given of an optical coupling device in accordance with a second embodiment of the present invention. The second embodiment is different from the first embodiment in that the terminals for a light emitting element and the signal terminals do not protrude through the side surfaces.

As shown in FIG. 4, the bottom surfaces of terminals 26a and 27a for a light emitting element and signal terminals 28a and 29a of an optical coupling device 2 are on the same plane as the bottom surface of the mold resin 35. Alternatively, the above terminals 26a, 27a, 28a and 29a slightly protrude to the side of the bottom surface of the mold resin 35. As compared to the optical coupling device 1 in accordance with the first embodiment, the wiring 18 connected to the terminal 26a for a light emitting lement is shorter, and the bonding wire 33 is directly connected to the terminal 27a for a light emitting element. A signal wire 25 connected to the signal terminal 28a is shorter, and the signal terminal 29a is directly connected to the switching circuit 16. The length of the signal wire 25 is extremely short, the length being approximately equivalent to the thickness of the signal terminal 29a.

As shown in FIG. 5A, the optical coupling device 2 has a structure (what is termed as a leadless type) in which the terminals 26a and 27a for a light emitting element and the signal terminals 28a and 29a, each having a rectangular shape, are exposed from the bottom surface of the mold resin 35. For example, the terminals 26a and 27a for a light emitting element and the signal terminals 28a and 29a may be connected to a printed circuit board (not shown) with solder. Incidentally, the sizes of the bottom surfaces of the terminals 26a and 27a for a light emitting element and the signal terminals 28a and 29a, the space intervals therebetween, and the like may be varied according to conditions of mounting.

As shown in FIG. 5B, the optical coupling device 2 may take a modified form of mounting. Specifically, the form is a structure (what is termed as a BGA (Ball Grid Array) type), which is formed by a procedure involving: forming a solder resist 71 on the exposed surfaces of the terminals 26a and 27a for a light emitting element and the signal terminals 28a and 29a and on the bottom surface of the mold resin 35; forming circular openings respectively in portions which is to be connected to the terminals 26a and 27a for a light emitting element and to the signal terminals 28a and 29a; and connecting, for example, solder balls 76 to the openings.

As mentioned above, the terminals 26a and 27a for a light emitting element and the signal terminals 28a and 29a do not protrude through the side surfaces of the optical coupling device 2 in accordance with the second embodiment. Moreover, the lengths of the respective wiring 18 and the signal wire 25 are made shorter. As compared to the optical coupling device 1 in accordance with the first embodiment, the terminals 26a and 27a for a light emitting element and the signal terminals 28a and 29a do not protrude through the side surfaces. As a consequence, the optical coupling device 2 is two-dimensionally smaller in size, and thus the mounting area can be made smaller.

In addition, the signal wire 25 having the shorter length makes it possible to reduce the inductance components of the signal wire 25. Thus, the optical coupling device 2 can further suppress the insertion loss of the high-frequency signal, as compared to the optical coupling device 1 in accordance with the first embodiment.

Since the optical coupling device 2 in accordance with the second embodiment can take two types of forms of mounting, the optical coupling device 2 may be employed in applied equipment which takes any one of these forms of mounting.

### Third Embodiment

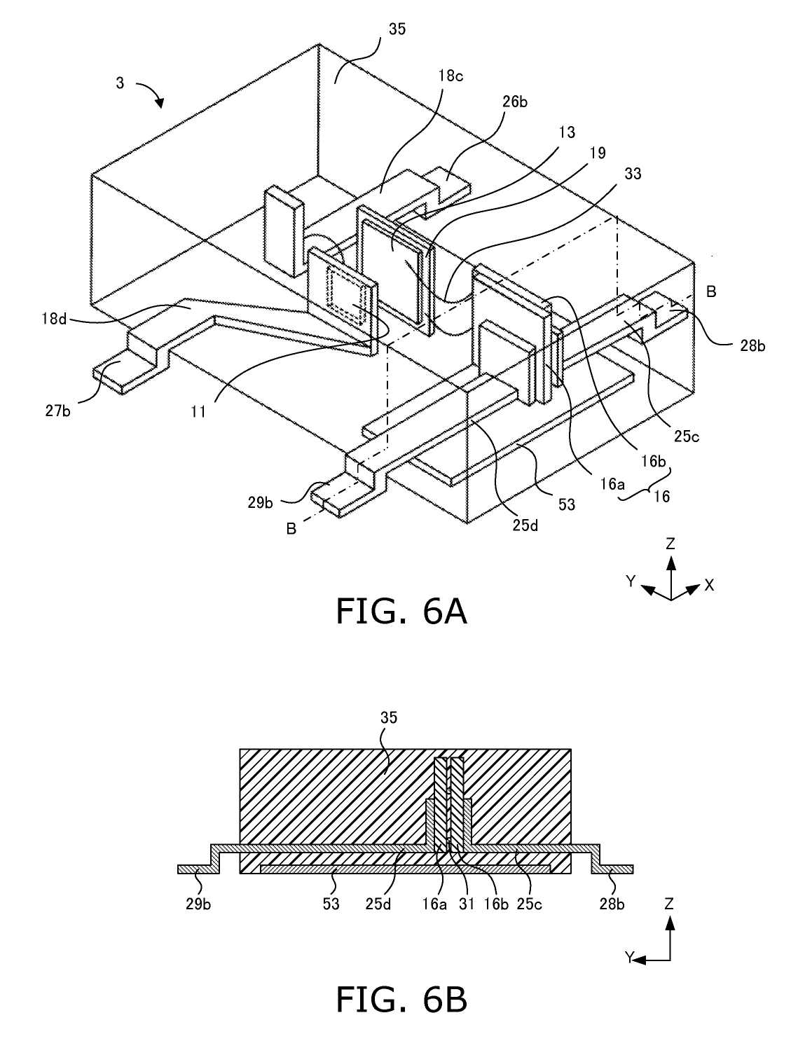

With reference to FIGS. 6A to 9, the descriptions will be given of an optical coupling device in accordance with a third embodiment of the present invention. The third embodiment is different from the first embodiment in that the light emitting element, the photodetector element array, the switching circuit, and the like are arranged perpendicular to the bottom surface, and that a base board is provided to the part of the bottom surface of the signal wire in order to adjust a characteristic impedance across signal wire terminals by setting the characteristic impedance at 50 Ω.

As shown in FIGS. 6A and 6B, the relationship between the light emitting element 11 and the photodetector element array 13 is the same as that of the first embodiment, except that the light emitting element 11 and the photodetector element array 13 are arranged substantially perpendicular to the mounting surface (or the bottom surface) formed of terminals 26b and 27b for a light emitting element and the like. The spatial position of an optical coupling system formed of the light emitting element 11 and the photodetector element array 13 is substantially the same as that of the first embodiment. Since the light emitting element 11 is mounted on the wiring connected to the terminal 27b for a light emitting element, the connections between the terminals 26b and 27b for a light emitting element and the anode and cathode of the light emitting element 11 are the reverse of those of the first embodiment.

The switching circuit 16 is arranged substantially perpendicular to the mounting surface in accordance with the arrangements of the light emitting element 11 and the photodetector element array 13. Signal wires 25c and 25d connected to the switching circuit 16 are different from those of the first embodiment in the following respect. One of the signal wires 25c and 25d connected to a signal terminal 28b, and the other connected to a signal terminal 29b do not overlap each other as viewed from a direction perpendicular to the bottom surface; and the signal wires 25c and 25d are arranged so as to support the switching circuit 16 on both of the right and left sides thereof, while maintaining a given distance between the switching circuit 16 and the bottom surface of the mold resin 35. Although the relationship between the switching circuit 16 and the signal terminals 28b and 29b is the reverse of that of the first embodiment, the switching circuit 16 is substantially identical regardless of directions of signal input and output. Thus, signals are transmitted in a similar way to that of the first embodiment.

As shown in FIG. 6B, the signal wire 25 has a base board 53, which is disposed at the side of the bottom surface, and between the signal terminals 28b and 29b with a predetermined distance (to be described later) interposed between the base board 53 and the bottom surface. The base board 53 extends in the directions of the signal terminals 28b and 29b to the vicinities of the side surfaces of the mold resin 35. The bottom surface of the base board 53 may be exposed so that the exposed bottom surface of the base board 53, when mounted, is electrically connected to a ground pattern (not shown) on the printed circuit board. The base board 53 is a conductor made of, for example, the similar metal to a lead frame. Meanwhile, the base board 53 may be made of, for example, copper, cobalt, tungsten, various alloys, or the like.

The signal wires 25c and 25d connected to the respective signal terminals 28b and 29b, are raised from the bottom surface outside the side surfaces of the mold resin 35, and the raised signal wires 25c and 25d are connected to the inside of the mold resin 35 through the side surfaces thereof. The form of terminal is what is termed as a gull wing type, which is different from the form shown in the first embodiment. However, the third embodiment may take a similar form of terminal (i.e., the leadless type) to that of the first embodiment in which the raised portions of the signal wires 25c and 25d are placed within the mold resin 35. In this case, the base board 53 is shortened in the directions of the signal wires 25c and 25d so as not to be in contact with the signal terminals 28b and 29b.

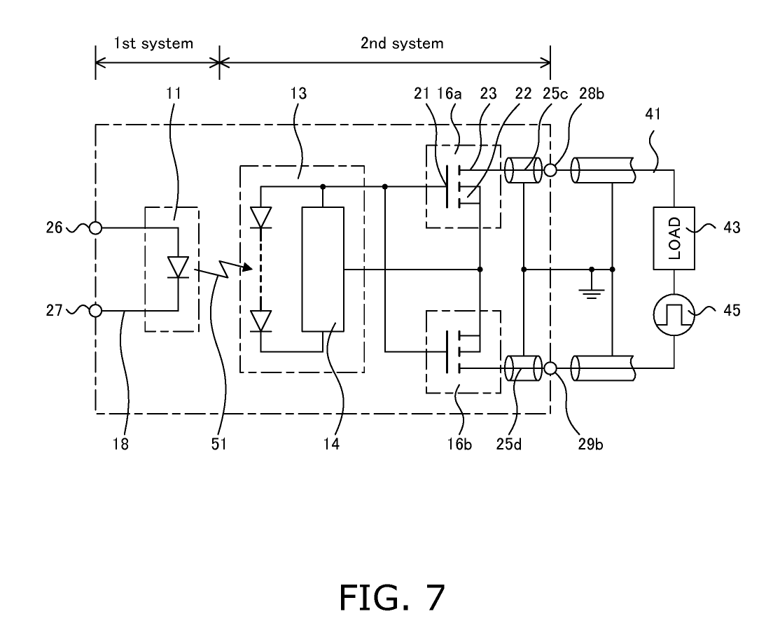

As shown in FIG. 7, the primary and secondary sides of an optical coupling device 3 are electrically isolated from each other, as in the case of the first embodiment. In other words, this configuration suppresses the electrical effect of the primary side upon the signal transmission path of the optical coupling device 3 connected to the external circuits, such as the load 43 and the signal generator 45, with the external signal wire 41.

The difference between the first and third embodiments in their equivalent circuits is that the circuit configuration is of a microstrip line type in which the signal wires 25c and 25d are provided with the base board 53 in order to match the characteristic impedance to 50Ω. Generally, the characteristic impedance of the external signal wire 41 is set at, for example, 50Ω. Thus, the characteristic impedances of the signal wires 25c and 25d can be likewise set at 50Ω in order to provide stable high-frequency operation.

In order to ensure the quality of the waveform of a signal, the base board 53 is used to set the characteristic impedances of the signal wires 25c and 25d at about 50Ω in accordance with the characteristic impedance of the external signal wire 41, as mentioned above.

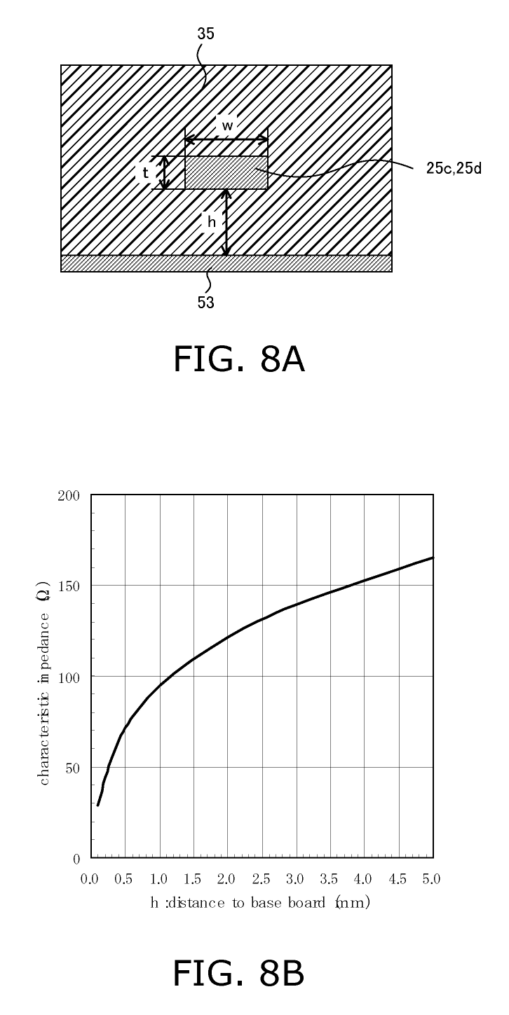

Referring to a cross sectional view of FIG. 8 illustrating the relative arrangements of the signal wires 25c and 25d and the base board 53 of the third embodiment, the characteristic impedance is determined by the width (w) and thickness (t) of the signal wires 25c and 25d, the distance (h) between the signal wires 25c and 25d and the base board 53, and the relative dielectric constant value of the mold resin 35. As shown in FIG. 8B, the characteristic impedance is varied as shown by a curve, when the distance (h) varies from 0.1 to 5.0 mm, provided that the width (w) is 0.4 mm, the thickness (t) is 0.15 mm, and the relative dielectric constant of the mold resin 35 is about 4 to 5.

The conventional optical coupling device is not provided with the base board 53. In other words, this case corresponds to an instance in which the distance between the signal wires and the base board 53 is more than 5 mm, thus resulting in a characteristic impedance of at least 150Ω or higher.

The third embodiment is designed to set the distance between the signal wires 25c and 25d and the base board 53 at about 0.25 mm, and thereby setting the characteristic impedance at about 50Ω.

As mentioned above, in the optical coupling device 3 in accordance with the third embodiment, the light emitting element 11, the photodetector element array 13, the switching circuit 16, and the like are arranged perpendicular to the bottom surface, and the base board 53 is provided to the side of the bottom surfaces of the signal wires 25c and 25d to match the characteristic impedance across the signal terminals 28b and 29b to 50Ω.

The characteristic impedance of the external signal wire 41 at 50Ω match the characteristic impedance of the signal wire 25a. Thereby, reflection of an high-frequency signal therebetween reduces as compared to a conventional case.

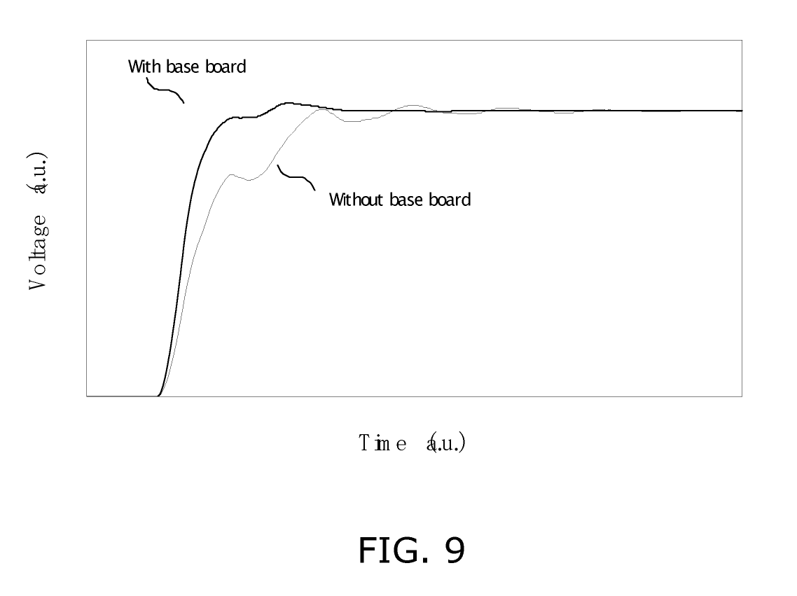

As shown in FIG. 9, the rise time of the optical coupling device 3 with the base board in accordance with the third embodiment is shorter as compared to that of the waveform of an output voltage which passes through the conventional optical coupling device without the base board. In short, high-frequency characteristics are improved in the optical coupling device 3.

In the conventional optical coupling device, situations may arise, for example, where the characteristic impedance varies because the distance between the device and the ground pattern varies depending on the position of the printed circuit board to be mounted. In contrast, the optical coupling device 3 is provided with the base board 53 in a predetermined position, thereby causing little variation in the characteristic impedance. Thus, the characteristics of transmitting the high-frequency signal with stability can be obtained. With the base board 53 provided to the optical coupling device 3, the signal wire 25a is less susceptible to noise.

The width across the two side surfaces respectively provided with the terminals for a light emitting element and the signal terminals may be reduced by arranging the light emitting element, the photodetector element array, the switching circuit, and the like perpendicular to the bottom surface. Out of the signal wires 25c and 25d connected to the switching circuit 16, one connected to the signal terminal 28b and the other connected to the signal terminal 29b maintain the given distance from the bottom surface of the mold resin 35. Hence, an impedance match between the characteristic impedances can be easily provided with the base board 53.

Hereinabove, the third embodiment is the optical coupling device 3 which is provided with the base board, and in which the light emitting element, the photodetector element array, the switching circuit and the like are arranged perpendicular to the bottom surface. However, it is possible to manufacture an optical coupling device which is not provided with the base board, and in which the light emitting element, the photodetector element array, the switching circuit and the like are arranged perpendicular to the bottom surface.

### Fourth Embodiment

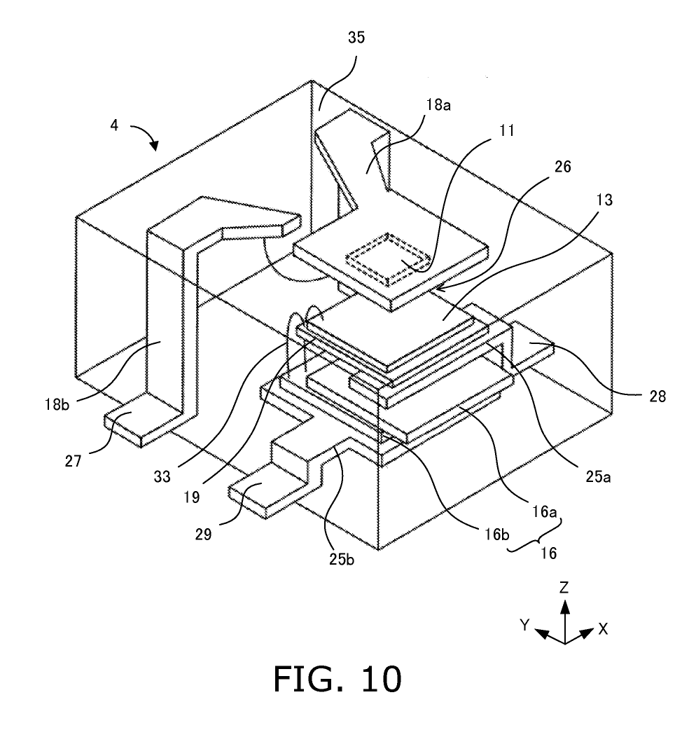

With reference to FIG. 10, the descriptions will be given of an optical coupling device in accordance with a fourth embodiment of the present invention. The fourth embodiment is different from the first embodiment in that the light emitting element and the photodetector element array are disposed above the switching circuit.

As shown in FIG. 10, the optical coupling device 4 has the same relative positions of the light emitting element 11 and the photodetector element array 13 as those of the first embodiment. However, an optical coupling device 4 has a spatial configuration in which the optical coupling system formed of the light emitting element 11 and the photodetector element array 13 is disposed above the switching circuit 16 disposed as in the case of the first embodiment.

Since the light emitting element 11 is placed at a higher position than that of the first embodiment, the wiring 18 connected to the terminals 26 and 27 for a light emitting element is extended in the height direction to a position where the light emitting element 11 is mounted and connected. The wiring 19, on which the photodetector element array 13 is mounted, is disposed above the signal wires 25a and 25b with space interposed between the photodetector element array 13 and the signal wires 25a and 25b. The photodetector element array 13 is fixed to the wiring 19 so as to face the light emitting element 11. An interstice between the light emitting element 11 and the photodetector element array 13 is filled with the transparent resin (not shown), as in the case of the first embodiment.

The terminals 26 and 27 for a light emitting element are disposed closer to the signal terminals 28 and 29 because the light emitting element 11, the photodetector element array 13 and the switching circuit 16 overlap one another two-dimensionally. In other words, the side surfaces provided with the terminals 26 and 27 for a light emitting element and the signal terminals 28 and 29 are made shorter.

The photodetector element array 13 and the switching circuit 16 are vertically connected to each other with the bonding wire 33.

The length between the side surfaces respectively provided with the terminals 26 and 27 for a light emitting element and the signal terminals 28 and 29 is the same as that of the first embodiment. Thus, the bottom surface of the mold resin 35 is smaller in area and greater in height, in correspondence with a reduction in the lengths of the side surfaces provided with the terminals 26 and 27 for a light emitting element and the signal terminals 28 and 29.

As compared to the optical coupling device 1 in accordance with the first embodiment, the optical coupling device 4 in accordance with the fourth embodiment achieves the shorter lengths of the respective side surfaces provided with the terminals 26 and 27 for a light emitting element and the signal terminals 28 and 29. Thereby, the bottom surface of the optical coupling device 4 has a still smaller area, and thus the mounting area thereof can be reduced.

### Fifth Embodiment

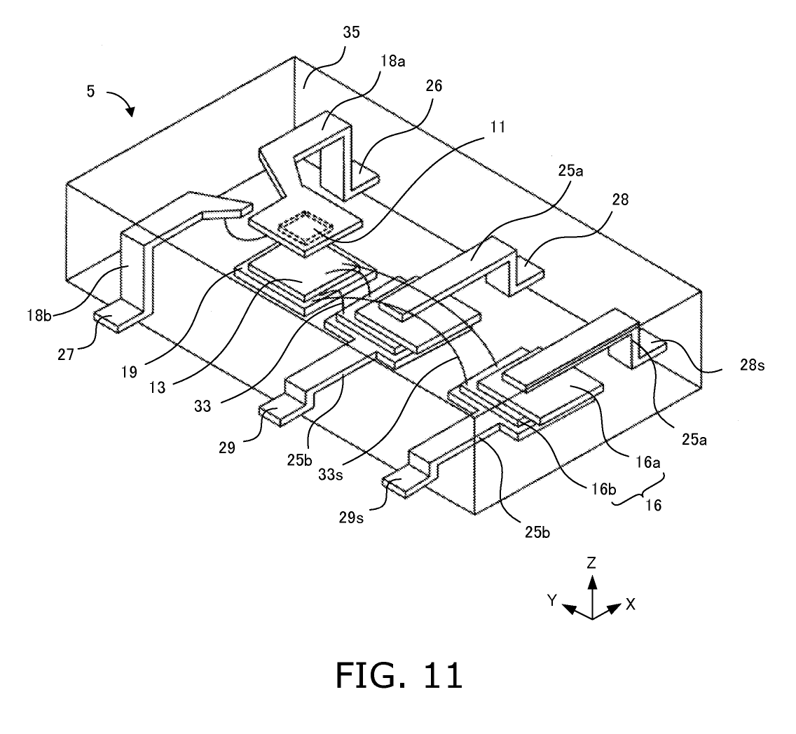

With reference to FIG. 11, the descriptions will be given of an optical coupling device in accordance with a fifth embodiment of the present invention. The fifth embodiment is different from the first embodiment in that another transmission path for high-frequency wave or the like is added in such a manner that two signal transmission paths are arranged in parallel with each other.

An optical coupling device 5 is adapted to evaluate an IC or the like which uses two transmission paths to transmit one signal. As shown in FIG. 11, another signal transmission path, which is formed of signal terminals 28s and 29s, the switching circuit 16 and the like, is disposed in the optical coupling device 1 in accordance with the first embodiment. Specifically, the signal transmission path is arranged adjacent to the signal transmission path corresponding to the optical coupling device 1, and is disposed opposite to the photodetector element array 13. These two transmission paths have the identical characteristics as the transmission paths. The signal terminals 28s and 29s are the same as the signal terminals 28 and 29, respectively. However, the letter “s” is added to each of the reference numerals for the former two terminals in order to distinguish between the two sets of transmission paths.

The switching circuit 16 of the transmission path that links the signal terminals 28s and 29s is connected, with a bonding wire 33s, to the photodetector element array 13 connected to the switching circuit 16 of the transmission path that links the signal terminals 28 and 29. The bonding wire 33s is disposed above and across the transmission path that links the signal terminals 28 and 29. Along with whether the light emitting element 11 is turned on or off, the two transmission paths, specifically the transmission path that links the signal terminals 28 and 29 and the transmission path that links the signal terminals 28s and 29s, can be in a conducting or non-conducting state in synchronization with each other. Incidentally, the lengths of the bonding wires 33 and 33s, e.g., several millimeters, are not significant because a signal passing through the bonding wires 33 and 33s is a control signal for continuity or noncontinuity of the switching circuit 16. A lead material for relay, rather than the bonding wire 33s alone, may be used for connection.

In the optical coupling device 5, the transmission path that links the signal terminals 28s and 29s is added in parallel to the transmission path that links the signal terminals 28 and 29. This results in the longer lengths of the respective side surfaces provided with the terminals 26 and 27 for a light emitting element and the signal terminals 28, 28s, 29 and 29s. Meanwhile, the width across the side surfaces and the heights thereof are the same as those of the optical coupling device 1 in accordance with the first embodiment.

In the optical coupling device 5 in accordance with the fifth embodiment, the additional transmission path that links the signal terminals 28s and 29s is disposed in parallel to the transmission path that links the signal terminals 28 and 29, as mentioned above. The switching circuit 16 through which a high-frequency signal is transmitted, the connection thereof and the like are the same as those of the first embodiment.

The two transmission paths are made to be in a conducting or non-conducting state in synchronization with each other, along with whether the light emitting element is turned on or off. Thus, the optical coupling device 5 can be used as a switching circuit for differential signal transmission, which is generally resistant to the effect of noise which is more serious as operating frequencies or the like is higher. Hence, in a case where the optical coupling device 5 is applied, for example, to an IC tester or the like for testing a semiconductor device of the differential signal transmission type, the semiconductor device can be evaluated while the effect of noise and the like are lessened, as compared to a case where two optical coupling devices each having one transmission path are used.

### Sixth Embodiment

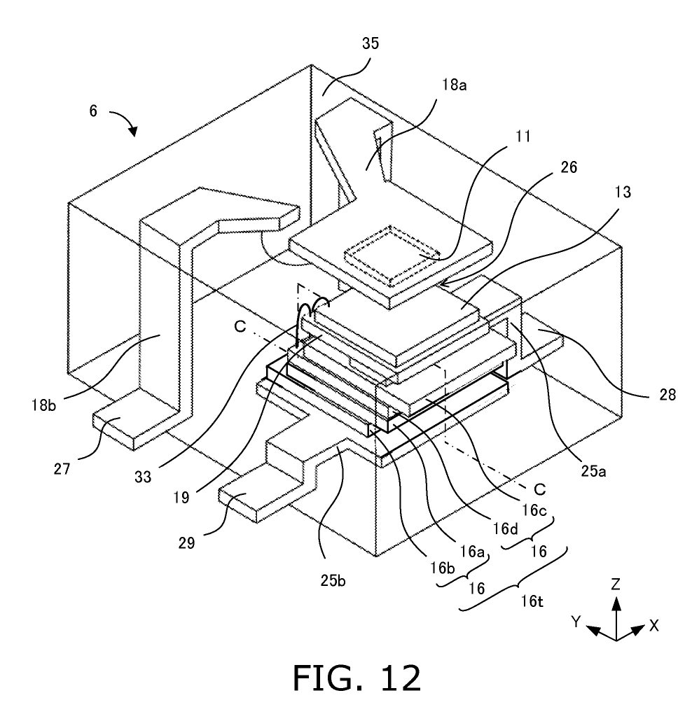

With reference to FIGS. 12 to 14, the description will be given of an optical coupling device in accordance with a sixth embodiment of the present invention. The sixth embodiment is different from the fourth embodiment in that the drains of two MOS elements disposed facing each other are connected together to form a switching circuit configured of four MOS elements.

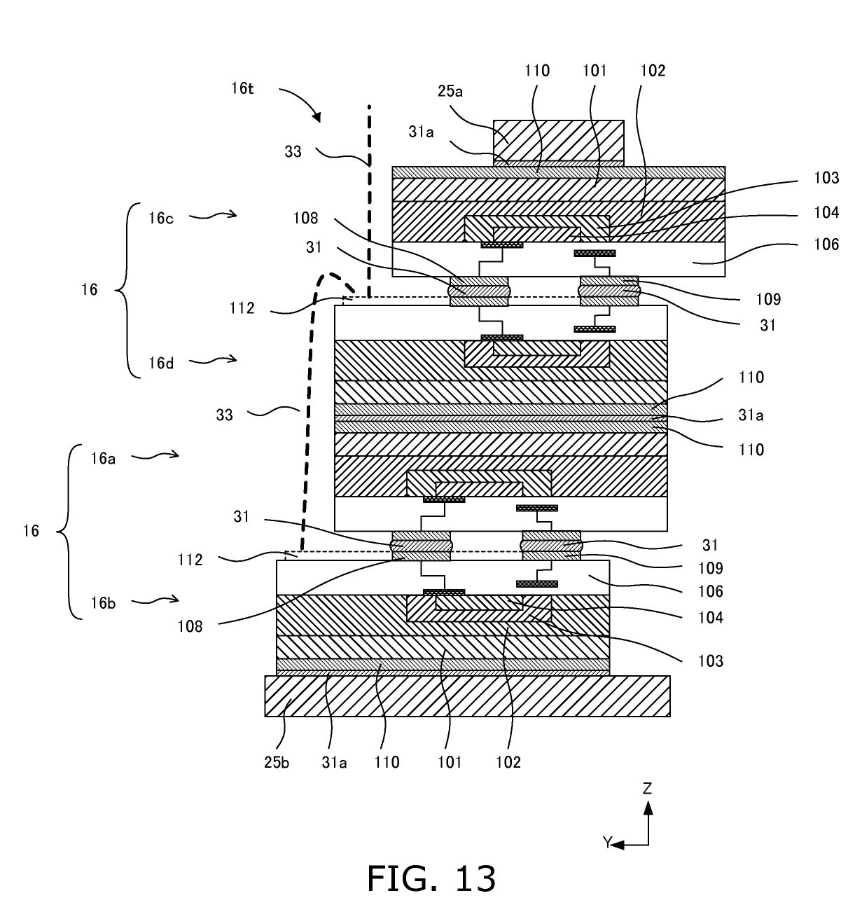

As shown in FIG. 12, a switching circuit 16t is provided with two switching circuits 16, each of which is the same as that of the first embodiment or the like. The drain that forms the rear surface of the MOS element 16a of one of the switching circuits 16 is connected to the drain that forms the rear surface of a MOS element 16d of the other switching circuit 16, with the conductive bonding material 31a (see FIG. 13), e.g., solder. Incidentally, the MOS element 16b is disposed in a position displaced horizontally relative to the position of the MOS element 16d so that wire bonding between the two switching circuits 16 is possible.

In the switching circuit 16t, the drain that forms the rear surface of the MOS element 16b is disposed at the side of the bottom surface, and the drain that forms the rear surface of a MOS element 16c is disposed at the side of the top surface. The bottom surface of the switching circuit 16t is connected to the signal wire 25b connected to the signal terminal 29. The top surface of the switching circuit 16t is connected to the signal wire 25a connected to the signal terminal 28. The height of the switching circuit 16t increases by the height of the added switching circuit 16, as compared to that of the fourth embodiment. Likewise, the height of the signal wire 25a connected to the signal terminal 28 increases by the height of the added switching circuit 16. Thus, an optical coupling device 6 is slightly higher than that of the optical coupling device 4 in accordance with the fourth embodiment, because the optical coupling system formed of the light emitting element 11 and the photodetector element array 13 is disposed above the switching circuit 16t as in the case of the fourth embodiment.

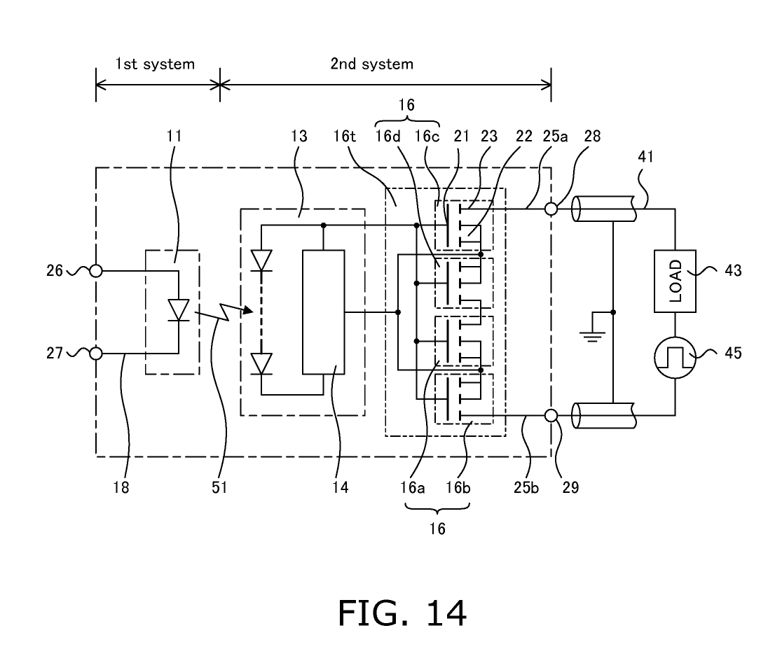

The description will now be given of a connection between the two switching circuits 16 within the switching circuit 16t. As shown in FIGS. 13 and 14, each of the switching circuits 16 is the same as the switching circuit 16 of the first embodiment. The switching circuit 16 having the MOS elements 16a and 16b and the switching circuit 16 having the MOS elements 16c and 16d are connected to each other with the bonding material 31a. The drains 23 (or the drain electrodes 110) of the MOS elements 16a and 16d face with each other. The gates 21 (or the gate electrodes 109) of the respective switching circuits 16 are connected to each other with the bonding wire 33 connected to the chip wiring 112, and the sources 22 (or the source electrodes 108) thereof are connected in the same manner. The switching circuits 16 are arranged so as to be horizontally displaced from the positions of each other in a way that the wire bonding is possible between the switching circuit 16 at the side of the top surface and the switching circuit 16 at the side of the bottom surface.

Accordingly, the optical coupling device 6 is capable of simultaneously providing continuity between the sources and the drains of the MOS elements 16a, 16b, 16c and 16d that constitute the switching circuit 16t. By providing the continuity through the switching circuit 16t, a transmission path for signals such as a high-frequency signal is ensured to run in the order of the signal terminal 28, the signal wire 25a, the MOS element 16c, the bonding material 31, the MOS element 16b, the signal wire 25b, and the signal terminal 29, as well as in the direction opposite the above order. This enables bidirectional transmission.

As mentioned above, the optical coupling device 6 in accordance with the sixth embodiment has a configuration in which a signal is transmitted by passing through twice as many MOS elements, namely 16a, 16b, 16c and 16d, as those of each of the first and fourth embodiments. In a case where the values of the isolation characteristics of the optical coupling devices 1 and 4 in accordance with the first and fourth embodiments are each, for example, −20 dB, the value of the isolation characteristics of the optical coupling device 6 in accordance with the sixth embodiment is consequently −40 dB, which is twice as much as that of each of the optical coupling devices 1 and 4. Thus, the optical coupling device 6 may be applied to the IC tester or the like that requires high isolation characteristics.

In a case where the optical coupling device requires higher isolation characteristics, the switching circuits 16 may be connected to each other in series in the same manner as the sixth embodiment to thereby easily yield an optical coupling device having further improved isolation characteristics.

### Seventh Embodiment

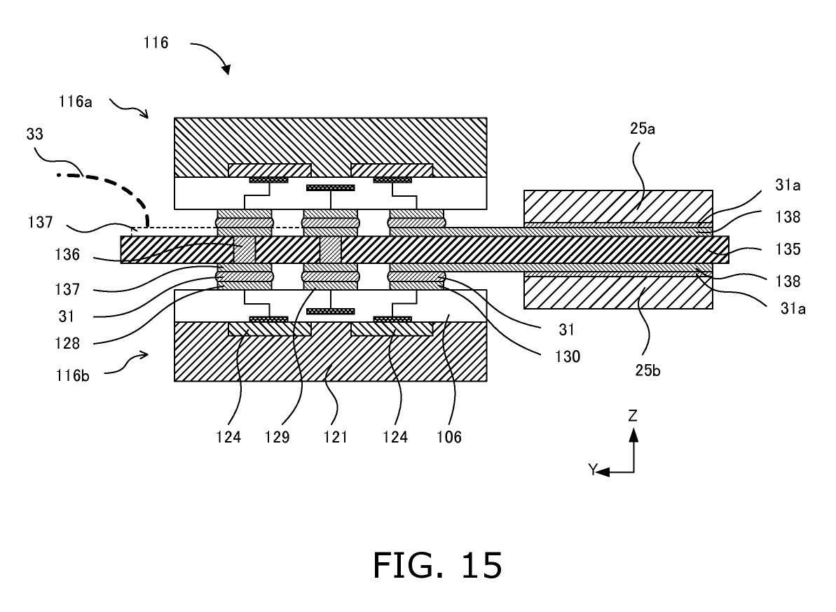

With reference to FIG. 15, the description will be given of an optical coupling device in accordance with a seventh embodiment of the present invention. The seventh embodiment is different from the first embodiment in that a lateral MOS element is used.

FIG. 15 illustrates a cross-sectional view of a position of the seventh embodiment, the position being identical to that shown in a cross-sectional view of the first embodiment shown in FIG. 3. As shown in FIG. 15, a switching circuit 116 is configured of MOS elements 116a and 116b which are arranged so as to face each other with an interposer 135 in between. A source electrode 128 and a gate electrode 129 are connected, with the bonding material 31, to wiring 137 on the interposer 135. A drain electrode 130 is connected, with the bonding material 31, to wiring 138 on the interposer 135.

For example, the MOS element 116b includes a p type semiconductor substrate 121 at the side of the bottom surface, and n type regions 124 are formed at the side of top surface (or the principal surface) of the p type semiconductor substrate 121 with space interposed in between each of the n type regions 124. The n type regions 124 are respectively connected to a source electrode 128 and a drain electrode 130. The insulating film 106 is formed so as to be in contact with the top surfaces of the semiconductor substrate 121, the n type regions 124 and the like. The gate electrode 129 is disposed with the insulating film 106 placed in between, above the top surface of a p type region between the n type regions 124 spaced from each other. The MOS element 116a has the same structure as the MOS element 116b.

The interposer 135 is an insulating substrate mainly made of an epoxy resin or the like. Alternatively, the interposer 135 may be made of ceramics or the like. The board wirings 137 and 138 made of copper foil, for example, are disposed on the top surface of the interposer 135 in positions corresponding to the source electrode 128, the gate electrode 129 and the drain electrode 130 of the MOS element 116a. The wiring 137 connected to the source electrode 128 and to the gate electrode 129 extends out to a first end of the interposer 135 at the side of the top surface thereof (the left part of FIG. 15). The wiring 138 connected to the drain electrode 130 extends out to a second end of the interposer 135 at the side of the top surface thereof (the right part of FIG. 15).

The board wirings 137 and 138 are disposed on the rear surface of the interposer 135 at positions corresponding to the source electrode 128, the gate electrode 129 and the drain electrode 130 of the MOS element 116b. The board wiring 138 connected to the drain electrode 130 extends out to the second end of the interposer 135 at the side of the rear surface thereof (the right part of FIG. 15).

The wirings 137 on the top and rear surfaces of the interposer 135, which are connected to the source electrodes 128, are connected to each other with through-hole wiring 136. The board wirings 137 on the top and rear surfaces of the interposer 135, which are connected to the gate electrodes 129, are connected to each other with through-hole wiring 136.

By replacing the switching circuit 116 of the seventh embodiment with the switching circuit 16 of the above-mentioned first embodiment, the optical coupling device (not shown) can be constituted. The positions and shapes of the signal wires 25a and 25b shown in FIGS. 1A and 1B and other configurations thereof are adjusted so that the signal wires 25a and 25b can be connected to the board wirings 138 on the interposer 135. The board wiring 137 is connected to the photodetector element array 13 with the bonding wire 33. Incidentally, an equivalent circuit of the optical coupling device in accordance with the seventh embodiment is the same as the equivalent circuit shown in FIG. 2.

As shown in FIG. 15, the signal wire 25a is connected, with the bonding material 31a, to the board wiring 138 on the top surface of the interposer 135. The signal wire 25b is connected, with the bonding material 31a, to the board wiring 138 on the rear surface of the interposer 135. Thereby, continuity is achieved between the sources (or the source electrode 128) and the drains (or the drain electrode 130) of the MOS elements 16a and 16b. Thus, a transmission path for signals such as a high-frequency signal is ensured to run in the order of the signal wire 25a, the board wiring 138, the bonding material 31, the MOS element 116a, the board wiring 138 and the signal wire 25b, as well as in the direction opposite the above order. This enables bidirectional transmission.

The optical coupling device (not shown) having the switching circuit 116 of the seventh embodiment has substantially the same effects as those of the optical coupling device 1 in accordance with the first embodiment.

As compared to the switching circuit 16 of the first embodiment, the switching circuit 116 has the increased inductance components corresponding to, for example, the board wiring 138. The board wiring 138, however, is much larger in cross-sectional area than the bonding wire or the like, because the board wirings 138 are formed on the top and rear surfaces of the interposer 135 by using the copper foil or the like. Thus, as compared to using the bonding wire, the inductance components is reduced. Moreover, the switching circuit 116 prevents the inductance components from increasing, as compared to the switching circuit 16 of the first embodiment. Consequently, the switching circuit 116 makes it possible to increase the range of operating frequencies of a transmitted signal to the range of frequencies exceeding the order of a gigahertz.

The MOS elements 116a and 116b that constitute the switching circuit 116 are designed in such a manner that the elements, the electrodes, and the like are collectively disposed at the side of the principal surface of the semiconductor substrate 121. Thereby, processes, such as forming the electrodes on the rear surface of the semiconductor substrate 121, are not needed. Thus, processes for manufacturing the MOS element can be simplified.

While the present invention has been described with reference to the specific embodiments, it is to be understood that the present invention is not limited to the above embodiments. It should be apparent that various modifications can be made thereto without departing from the spirit and scope of the invention.

An example shown with the embodiments is the optical coupling device including the optical coupling system having the light emitting element and the photodetector element array, and one or two signal transmission paths which pass through the switching circuit. Meanwhile, a multichannel optical coupling device may be manufactured. Specifically, this optical coupling device may be configured of a plurality of optical coupling devices arranged in parallel and fixed by the same mold resin, each of which is any one of the optical coupling devices described with reference to the embodiments. The terminals for a light emitting element and the signal terminals therefore in an optical coupling device can be independently controlled for each channel.

An instance shown with the embodiments is one where the solder bump is formed to bond together the MOS elements of the switching circuit. The bonding material, however, may be made of conductive paste such as gold or silver paste, an anisotropic conductive resin, a material including a combination of these materials, or the like.

The embodiments have shown an instance where optical coupling is accomplished by disposing the light emitting element and the photodetector element array as facing each other. However, optical coupling of a reflection type, or of other types may be adopted. Specifically, in the reflection-type optical coupling, light from the light emitting element is reflected. Thereby, the light enters into the photodetector element array.

The use of the LED which emits an infrared beam of light has been given as an example with reference to the embodiments. However, red light with relatively short wavelengths, or other light beams may be used. A light source is not limited to the LED, and may be of other types such as an LD (Laser Diode).

With reference to the embodiments, the descriptions has been given of the gull wing type, the leadless type, the BGA type and the like as examples of the forms of the terminals for a light emitting element and the signal terminals which are connected to the wiring and to the signal wires. In each of the embodiments, however, any one of the gull wing, leadless, BGA and other types can be selected. Thereby, a different form of optical coupling device can be obtained.

An example shown with the fifth embodiment is the manufacture of the optical coupling device in which one signal transmission path described with reference to the first embodiment is added in such a manner that two signal transmission paths are arranged in parallel with each other. In other embodiments as well, the optical coupling device may be manufactured in the same manner by adding one signal transmission path to form the parallel arrangement of two signal transmission paths. As for the signal transmission path of the conventional optical coupling device including the switching circuit configured of the two MOS elements connected to each other with the bonding wire, it is needless to say that a differential signal can be transmitted even when one signal transmission path is added to form the parallel arrangement of two signal transmission paths.

In the seventh embodiment, a given example is one where the switching circuit configured of the lateral MOS elements is applied to the first embodiment. The switching circuit configured of the lateral MOS elements, however, may be applied to any one of other embodiments, such as the second to fifth embodiments.

The following configurations as defined in the appended notes (1) to (7) can be considered for the present invention:

(1) An optical coupling device, which includes a light emitting element, a photodetector element, and a switching circuit having first and second semiconductor elements and electrodes. The photodetector element receives light from the light emitting element. In the switching circuit, the first and second semiconductor elements are disposed so as to face each other, and are turned on and off under control based on a signal from the photodetector element. The electrodes are respectively formed on surfaces, facing each other, of the first and second semiconductor elements, and are connected to each other,

(2) The optical coupling device as defined in (1), in which a vicinity of the second semiconductor element is disposed in a position not facing the first semiconductor element.

(3) The optical coupling device as defined in (2), in which the vicinity of the second semiconductor element is displaced with respect to a position of the first semiconductor element so that the vicinity of the second semiconductor element is disposed in the position not facing the first semiconductor element.

(4) The optical coupling device as defined in (1), which further includes the photodetector element disposed so as to face the light emitting element; the switching circuit disposed on the photodetector element on a side thereof facing the light emitting element; and an external terminal disposed on a side of the switching circuit on a side thereof facing the light emitting element.

(5) The optical coupling device as defined in (1), in which the sources and drains of the first and second semiconductor elements are disposed on the principal surfaces of the semiconductor substrates.

(6) The optical coupling device as defined in (1), in which the electrodes formed on the surfaces of the first and second semiconductor elements, which face each other, are connected, by using the bonding material, with the wiring, which is formed on the insulating substrate, placed in between.

(7) The optical coupling device as defined in (1), which further includes an external terminal of the gull wing type, the leadless type, or the BGA type.

1. An optical coupling device comprising:
a light emitting element;
a photodetector element which receives light from the light emitting element; and
a first switching circuit in which first and second semiconductor elements are disposed are so as to face each other, and are turned on and off under control based on a signal from the photodetector, and in which electrodes are respectively formed on surfaces of the first and second semiconductor elements, said electrodes facing each other and are connected to each other.

2. The optical coupling device according to claim 1, wherein the electrodes formed on the surfaces of the first and second semiconductor elements are connected to each other with a bonding material.

3. The optical coupling device according to claim 1, wherein each of the first and second semiconductor elements has a source disposed on a principal surface of a semiconductor substrate and a drain disposed on a rear surface opposite the principal surface of the semiconductor substrate.

4. The optical coupling device according to claim 3, further comprising a metal board disposed in close proximity to signal wires which connect the respective drains of the first and second semiconductor elements to an external circuit.

5. The optical coupling device according to claim 4, further comprising a second switching circuit which is equivalent to the first switching circuit, and which is disposed in parallel to the first switching circuit.

6. The optical coupling device according to claim 3, wherein the bonding material is a solder bump.

7. The optical coupling device according to claim 1, wherein
the first and second semiconductor elements are MOSFETs,
the gates of the first and second semiconductor elements are connected to each other, and
the sources thereof are connected to each other.

8. The optical coupling device according to claim 7, wherein each of the MOSFETs is a vertical MOSFET.

10. The optical coupling device according to claim 1, wherein the first switching circuit is disposed above the light emitting element with a space interposed between the first switching circuit and the light emitting element.

11. The optical coupling device according to claim 1, wherein the first switching circuit is disposed below the photodetector element with a space interposed between the first switching circuit and the light emitting element.

12. The optical coupling device according to claim 1, wherein the light emitting element, the photodetector element, and the first and second semiconductor elements are arranged perpendicular to a bottom surface of the optical coupling device.

13. An optical coupling device comprising:
a light emitting element;
a photodetector element which receives light from the light emitting element; and
a first switching circuit having a first MOS element and a second MOS element disposed so as to overlap the first MOS element, the first MOS element being turned on and off as controlled by a signal from the photodetector element,
the optical coupling device wherein
a gate of the first MOS element is connected to a gate of the second MOS element with a bonding material, and
a source of the first MOS element is connected to a source of the second MOS element by a bonding material.

14. The optical coupling device according to claim 13, wherein the bonding material is a solder bump.

15. The optical coupling device according to claim 13, wherein the light emitting element, the photodetector element, and the first and second MOS elements are arranged perpendicular to a bottom surface of the optical coupling device.

16. The optical coupling device according to claim 13, wherein the first switching circuit is disposed above the light emitting element with a space interposed between the light emitting element and the first switching circuit.

17. The optical coupling device according to claim 13, wherein the first switching circuit is disposed below the photodetector element with a space interposed between the light emitting element and the first switching circuit.

18. The optical coupling device according to claim 13, wherein a part of the first MOS elements does not overlap a part of the second MOS element.

19. The optical coupling device according to claim 18, further comprising a second switching circuit which is equivalent to the first switching circuit, and which is disposed in parallel to the first switching circuit.

20. The optical coupling device according to claim 13, further comprising a metal board disposed in close proximity to signal wires which connect the respective drains of the first and second MOS elements to an external circuit.
